(19) United States
(12) Patent Application Publication
(10) Pub. No.: US 2023/0235469 A1
(43) Pub. Date: Jul. 27, 2023

(54) METHOD FOR OPERATING A WATER ELECTROLYSIS DEVICE

(71) Applicant: Hoeller Electrolyzer GmbH, Wismar (DE)

(72) Inventor: Stefan HÖLLER, Lübeck (DE)

(21) Appl. No.: 17/923,266

(22) PCT Filed: May 15, 2020
(86) PCT No.: PCT/EP2020/063724

§ 371 Date: Nov. 4, 2022

(51) Int. Cl. C25B 15/08; C25B 1/04; C25B 9/19; C25B 9/67; C25B 9/13; C25B 15/027; C25B 15/021

(52) U.S. Cl. CPC C25B 15/087; C25B 1/04; C25B 9/19; C25B 9/67; C25B 9/13; C25B 15/083; C25B 15/085; C25B 15/027; C25B 15/021

(57) ABSTRACT

The method for operating a water electrolysis device for generating hydrogen and oxygen from water has a PEM electrolyser (1), to which water for generating the hydrogen and the oxygen is supplied together with water for cooling. The cooling water is conducted in the circuit and treated by means of an ion exchanger unit (17). Only part of the water conducted in the circuit is supplied to the ion exchanger unit (17) and another part is supplied to the PEM electrolyser (1) via a bypass (13) circumventing the ion exchanger unit (17).

### CROSS REFERENCE TO RELATED APPLICATIONS

This application is a United States National Phase Application of International Application PCT/EP2020/063724, filed May 15, 2020.

### TECHNICAL FIELD

The invention relates to a method for operating a water electrolysis device having the features specified in the preamble of claim 1 and a water electrolysis device for executing the method according to the invention having the features specified in the preamble of claim 5.

### BACKGROUND

A water electrolysis device of the type being discussed is for example known from WO 2018/196947 A1. There, reaction water, which is broken down electrolytically to hydrogen and oxygen, together with cooling water is fed to a PEM electrolyser (Polymer Electrolyte Membrane), in which one part of the water is broken down into oxygen and hydrogen and another part, which is provided for cooling the PEM electrolyser, is guided into a cooling circuit. The water exiting from the PEM electrolyser together with the oxygen is supplied to a separation and collection chamber, in which the oxygen is removed and, if required, demineralized water is supplied as a replacement.

During the operation of this electrolysis device, metal ions are released in the PEM electrolyser, which negatively influence the electrolysis process during the renewed supply of the water and damage the PEM electrolyser. In order to prevent this, an ion exchanger is connected upstream of the PEM electrolyser, which ensures that these metal ions are removed from the water, before this water is supplied to the PEM electrolyser.

An ion exchanger of this type constitutes an increased hydraulic resistance in the water circuit and thus entails an increased pump power, in order to maintain the circuit. In order to be able to operate the PEM electrolyser as optimally as possible, the operating temperature should be at least 70° C. and in future systems up to 120° C. However, one problem in this case is that the water supplied to the ion exchanger can only have a temperature of maximum 60° C. Therefore, expensive heat exchange measures are required in order to cool down the water supplied to the ion exchanger initially to 60° C. and then to heat the water exiting the ion exchanger to 70° C. or more, in order to ensure an operating temperature of the PEM electrolyser, which is as optimal as possible. From WO 2018/196947 A1, it is included in the prior art by means of suitable heating/cooling circuits to realize the same with a minimum of energetic outlay.

### SUMMARY

The present invention is based on an object of further improving a generic method for operating a water electrolysis device for generating hydrogen and oxygen from water and furthermore providing a suitable water electrolysis device for carrying out such an improved method.

The method-related part of this object is achieved by a method having the features according to the invention. The device-related part of this object is achieved by a water electrolysis device having the features specified in the invention. Advantageous embodiments of the method and the device are specified in the sub-claims, the following description and the drawings.

In the method according to the invention for operating a water electrolysis device for generating hydrogen and oxygen from water, water for generating the hydrogen and the oxygen together with water for cooling is supplied to a PEM electrolyser, particularly a PEM electrolysis stack, and the water for cooling is carried in the circuit and treated by means of a cleaning and/or separating device, for example an ion exchanger. According to the invention, it is provided to supply only part of the water carried in the circuit to the cleaning and/or separating device and to supply a different part to the PEM electrolyser via a bypass whilst bypassing the cleaning and/or separating device.

The basic idea of the method according to the invention is to supply only so much of the water carried in the circuit to the cleaning and/or separating device that it is ensured that the water quality supplied to the PEM electrolyser is satisfactory to ensure long-term stable operation of the same. It has surprisingly been shown that it may be sufficient to supply only a partial flow of the water carried in the cooling circuit to the cleaning and/or separating device and to supply the other partial flow to the PEM electrolyser directly via a bypass whilst bypassing the cleaning and/or separating device, in order to ensure the water quality required for the long-term operation of the PEM electrolyser.

The method according to the invention has the advantage that important advantages are achieved by the bypass. If, for example, an ion exchanger is provided as cleaning and/or separating device, then the water carried in the bypass does not need to be cooled down or heated, as is required during passage through the ion exchanger, it may generally be supplied directly to the PEM electrolyser without further temperature treatment. If appropriate, cooling may be provided in the cooling water circuit, which lowers the entirety of the water carried in the circuit to a temperature which is advantageous for operating the PEM electrolyser. A further temperature drop needs to take place only for the partial flow of the water, which is supplied to the cleaning and/or separating device, particularly the ion exchanger. Also, the subsequently exiting water flow only has to be heated to this extent. Furthermore, the method according to the invention makes it possible to guide a majority of the water circuit through the bypass, which is already advantageous with regards to the pump power to be applied for the circulation. The bypass can be formed by a line or lines which is/are satisfactorily dimensioned in cross section, as a result of which, the pump power required for circulating the water can be reduced considerably. Only the partial flow passed through the cleaning and/or separating device must, if necessary, be brought to a higher pressure level in order to get through this device. Finally, the intervals in which the material to be replaced, whether it be ion exchanger material, filter material or the like, can be lengthened compared to the prior art, in which the entire cooling water flow is passed through the cleaning and/or separating device.

Cleaning and/or separating device in the sense of the present invention is to be understood to mean any device that is required or even only suitable for treating the water supplied to the PEM electrolyser, which replaces, exchanges or retains particles entrained in the water flow down to atomic components/ions, etc. These may for example be filters, particularly activated carbon or else membrane filters, or else ion exchangers or other suitable treatment devices.

It is particularly advantageous to use the method according to the invention if an ion exchanger is used as cleaning and/or separating device, as such an ion exchanger is advantageous for the long-term stable operation of the PEM electrolysis stack, as it reliably removes the metal ions dissolved in the PEM electrolyser and entrained in the cooling water circuit. In this case, two ion exchangers are advantageously connected in series to form an ion exchanger unit, wherein the replacement of the ion exchanger material expediently takes place in such a manner that the same is not replaced simultaneously in both ion exchangers, but rather that the ion exchanger material of the secondary ion exchanger in the flow direction is used in the ion exchanger connected upstream of the same and the material removed in the secondary ion exchanger is replaced by new ion exchanger material. A high exchange quality is achieved in this manner.

The basic idea of the method according to the invention of guiding only a partial flow through the cleaning and/or separating device is limited by the quality requirements on the water supplied to the PEM electrolyser. Particularly when using an ion exchanger as cleaning and/or separating device, it has proven advantageous if the ratio of the partial flows of the cooling circuit, that is to say of the partial flow which flows through the cleaning and/or separating device to the partial flow which flows through the bypass, is set up such that the water quantity which is guided through the cleaning and/or separating device every hour is at least four times as large as the water quantity carried in the cooling circuit. As a result, this leads to the water carried in the cooling circuit every hour being guided through the cleaning and/or separating device at least four times. This value is to be adapted to the environment, that is to say depends on the cleaning and/or separating device used and the materials used in the PEM electrolyser and the operating conditions. The above dimensioning is advantageous when using an ion exchanger as cleaning and/or separating device in particular, in order to ensure the long-term operation of the PEM electrolysis stack.

According to an advantageous development of the method according to the invention, during the start-up of the water electrolysis device, the water carried in the circuit is initially not yet carried in the bypass at all, but rather exclusively guided through the cleaning and/or separating device, in order to ensure that a sufficiently high water quality is ensured, even at the start. This takes place in an expedient manner until at least one predetermined quality value of the water is achieved, whereupon the bypass of the circuit to bypass the cleaning and/or separating device is then enabled in stages, continuously or completely. If using an ion exchanger as cleaning and/or separating device, this value is determined by the number of the metal ions entrained in the water. As it is very expensive to determine this number, it has been proven in practice to shut off the bypass in a time-controlled manner during the start-up of the water electrolysis device, wherein the time is chosen such that the water carried in the cooling circuit has then reliably reached or exceeded a predetermined quality value after this time.

The water electrolysis device according to the invention is provided to carry out the method according to the invention. This device has a PEM electrolyser, particularly a PEM electrolysis stack, in which a multiplicity of PEM electrolysis cells are installed to form a stack, and which is incorporated into a cooling water circuit, via which the reaction water is also supplied, which is broken down to hydrogen and oxygen using electrical energy. The water electrolysis device has a cleaning and/or separating device, which is connected upstream of the electrolyser. According to the invention, a bypass is provided, via which water can be supplied to the electrolyser, bypassing the cleaning and/or separating device.

Bypass in the sense of the invention is basically to be understood to mean any desired fluid-conveying connection which bypasses the cleaning and/or separating device, that is to say produces a direct line connection to the PEM electrolyser. This may typically be a pipeline, a line connection of this type may however also be formed by a set, a housing part or the like. It is essential in this case that a partial flow is guided past the cleaning and/or separating device, that is to say is arranged parallel to the same and ensures a direct line connection to the PEM electrolyser.

In order to remove the metal ions located in the cooling circuit, the cleaning and/or separating device advantageously has an ion exchanger. In this case, it is particularly expedient to connect two ion exchangers in series to form an ion exchanger unit and as explained above, to maintain the same in such a manner that the ion exchange material is constantly changed from the downstream-connected ion exchanger in the flow direction to the upstream-connected ion exchanger and the ion exchange material from the downstream-connected ion exchanger in the flow direction is renewed.

Advantageously, in this case, a plurality of such series-connected ion-exchanger pairs, which form an ion exchanger unit, are connected in parallel, wherein the number is advantageously chosen in such a manner that in the case of maximum throughflow, that is to say if applicable, when the bypass is shut off, the capacity is dimensioned such that one ion exchanger unit can be switched off for maintenance purposes. Then, it is ensured that the maintenance required at regular time intervals during continuous operation of the water electrolysis device can take place without interrupting the gas production process. One such arrangement can be used analogously when using filters, whether to replace the filter material or else for backflushing. In this case, the capacity of maximum throughflow is not necessarily to be adapted to the start-up process, in which the bypass is shut off, it is sufficient here to consider the started-up state of the electrolysis device.

According to a development of the invention, the cleaning and/or separating device can have at least one filter, for example an activated carbon filter and/or a membrane filter, in order to stop particles entrained in the water flow or to absorb constituents chemically. When using an ion exchanger or an ion exchanger unit in particular, it is advantageous to cool the water supplied to the cleaning and/or separating device prior to its entry into the device and to arrange a cooling device or a heat exchanger of a cooling device connected upstream for this purpose. Peltier elements, which are arranged at a suitable location, can for example be used as cooling device. If using a conventional cooling set or in the case of decentralized cooling, the arrangement of one or more heat exchangers upstream of the inlet to the cleaning and/or separating device, particularly the ion exchanger unit, will be provided.

In order to heat the water exiting from the cleaning and/or separating device to a temperature which is in the region of the operating temperature of the PEM electrolyser, a heating device or a heat exchanger of a heating device can be provided connected downstream. An electric heating system can for example be provided as heating device, a heat exchanger may be part of a heating circuit, the heat generation of which takes place at a different suitable location or transfers the heat from the cooling water exiting from the PEM electrolyser.

In principle, it is necessary for the circulation of the water in the cooling circuit to arrange for a pressure increase at a suitable location in the circuit. This may take place by utilizing the pressure of the reaction gases generated during the electrolysis or else by means of suitable, typically electomotively driven, centrifugal pumps. Whilst in the prior art, this central circulation pump is always to be dimensioned such that the entire cooling flow can also be conveyed through the cleaning and/or separating device, in the case of the device according to the invention, such a pressure-increasing device, which loads the entire cooling circuit, can be dimensioned to be considerably smaller, if a further pressure-increasing device, typically a further circulation pump, is only provided for the partial flow which has to be guided through the cleaning and/or separating device. Thus, it may be sufficient in practice if one pump, which generates a pressure increase of 0.5 bar for example, is provided for the circulation of the entire circuit, whereas a separate circulation pump can be used for the part guided through the cleaning and/or separating device, particularly when using ion exchangers, which separate circulation pump admittedly generates a pressure increase by 1.2 bar to 1.5 bar, but can be dimensioned to be considerably smaller quantitatively owing to the lower partial flow during continuous operation. It is understood that if for example, the entire cooling flow is conveyed through the cleaning and/or separating device during the start-up of the electrolysis device, this pump is then to be driven at a higher power, if appropriate for a short time, in order to be able to convey the entire flow through. As cooling is practically not required during start-up, this total water flow may be comparatively small however.

Alternatively, separate circulation pumps may be provided in both flow paths, that is to say in the bypass and in the line branch leading through the cleaning and/or separating device, then it is possible to dispense with a pump conveying the entire cooling water flow.

As at least during operation of the electrolysis device when started up, heat is to be removed from the PEM electrolyser, it is expedient to preferably assign the heat exchangers connected upstream and downstream of the cooling and/or heating device to a common temperature control circuit. Thus the water exiting from the PEM electrolyser can for example exchange heat with the water exiting from the cleaning and/or cooling device, in order to heat the latter water to the desired operating temperature, if possible. On the other hand, the water cooled there by means of heat exchange can be supplied to a heat exchanger connected upstream of the cleaning and/or separating device, in order to cool down the temperature of the incoming water. A cooling set is incorporated into the temperature control circuit, in order to ensure the required level of cold, if appropriate.

In order to actuate the temperature control of the entire cooling water flow, the temperature control of the partial flow passed through the cleaning and/or cooling device and the pumps required for the circulation in a suitable manner, a central control system is advantageously to be provided, using which the start-up of the water electrolysis device can for example be controlled automatically and using which the limit values required during operation can be adhered to by means of suitable feedback control systems. Typically, not only the circulation pumps for the cooling water circuit and the partial flows, but also the circulation pumps of the temperature control circuit are integrated into such a control system, as well as the mixing valves provided in the temperature control circuit and also the shut-off valve which closes or partially closes the bypass.

In the following, the system disclosed herein is explained in greater detail with reference to the accompanying figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is circuit diagram of a water electrolysis device according to the invention in a simplified illustration;

FIG. 2 is an alternative embodiment of the integration of a cleaning and/or separating device, and;

FIG. 3 is a further configuration of the integration of a cleaning and/or separating device.

### DESCRIPTION OF PREFERRED EMBODIMENTS

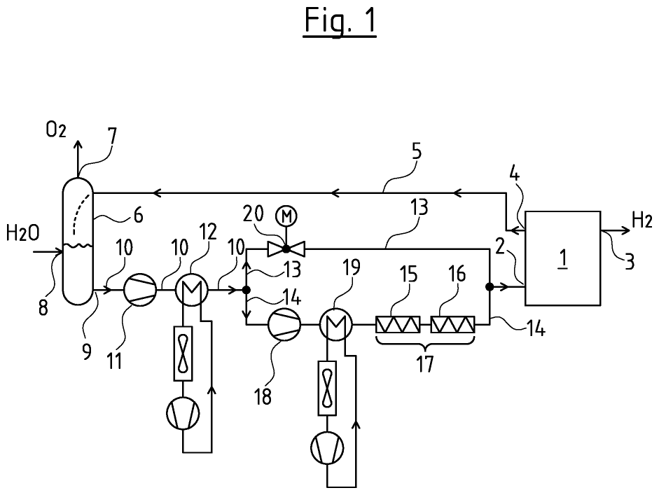

Referring to the drawings, the water electrolysis device according to FIG. 1 has an electrolyser 1 of Polymer Electrolyte Membrane configuration, which is formed as a stack, that is to say as a stack of a multiplicity of individual cells, which adjoin one another, and in which water is supplied via an inlet 2, specifically on the one hand as a reactant and on the other hand as a cooling fluid. Part of this supplied water is electrolytically broken down to hydrogen and oxygen using electric current. The hydrogen is removed via an output 3 of the electrolyser, the oxygen reaches a container 6 via an output 4 together with the excess water via a line 5.

The container 6 forms a gas separator and at the upper side thereof, the oxygen collected there is removed via a line 7. Demineralized water is supplied via an inlet 8, in order to replace the water converted into hydrogen and oxygen by the electrolytic breakdown in the electrolyser 1. The container 6 has an output 9, which is connected via a line 10 first to a circulation pump 11 for the cooling water circuit and then to a heat exchanger 12 of a cooling set. At the end of the line 10, the line divides into a line 13 forming a bypass, labelled with 13 in the figures, and a line 14 parallel thereto, in which a water treatment device in the form of two ion exchangers 15 and 16 connected one behind the other is incorporated. In the line 14, a circulation pump 18 and downstream a heat exchanger 19 of a cooling set are arranged upstream of the ion exchanger unit 17 formed by the ion exchangers 15 and 16. A shut-off valve 20 is arranged in the line 13 forming the bypass, which is electromotively controlled. The line 13 forming the bypass and the line 14, which contains the water treatment device 17, are merged at the output side and open at the inlet 2 of the electrolyser 1.

During operation of the device when started up, water is fed to the electrolyser 1 via the inlet 2. This water is broken down electrolytically into hydrogen and oxygen using electrical energy, the hydrogen is removed via the output 3, the oxygen leaves the output 4 of the electrolyser 1 together with the excess water. The water-oxygen mixture reaches the container 6 via the line 5, in which container the oxygen is removed via the line 7 and the water is removed via the line 10 connected at the output 9, if appropriate with the supply of further demineralized water via the inlet 8.

This heated water is, where necessary, cooled down by means of a heat exchanger 12, to a temperature which corresponds approximately to the desired operating temperature of the electrolyser 1, that is to say for example approximately 70° C. This water then reaches the lines 13 and 14, wherein the quantitative proportion of the lines 13 and 14 is controlled by means of the valve 20 or controlled to predetermined desired values. Alternatively or additionally, this can take place by actuating the variable speed circulation pump 18, which increases the pressure level inside the line 14, in order to be able to overcome the hydraulic resistance increased by the heat exchanger 19 and the downstream-connected ion exchanger unit 17.

The water carried in the line 14 is cooled by means of the heat exchanger 19 to a temperature of 60° C., this is the maximum permitted temperature for the operation of the ion exchanger unit 17. The water exiting the ion exchanger unit 17 then makes it back into the inlet 2 of the electrolyser together with the water coming from the line 13. The ratio of the partial flows of the lines 13 and 14 is chosen in such a manner that the partial flow through the line 13 is as large as possible and the partial flow through the line 14 is as large as necessary, so that the cleaning and/or separating treatment of this water is sufficient in order not to damage the electrolyser 1 during operation. As the water quantity required for cooling the electrolyser 1 and to be circulated is substantially larger than the water quantity to be cleaned, during operation when run in, a flow rate which is typically ten to thirty times as high as that in the line 14 results in the line 13.

If the previously described water electrolysis device has to be started up after maintenance works or after an interruption to operation, the proportion of the metal ions located in the water is typically excessive, which is why during the start-up of the device, first the valve 20 is actuated in a completely closing manner, so that the whole of the water flow supplied to the electrolyser 1 via the inlet 2 is conveyed through the line 14 and thus through the ion exchanger unit 17, in order to ensure that an impermissibly high loading of the electrolyser 1 with metal ions does not develop even in this start-up situation. The valve 20 is opened either in a time-controlled or temperature-controlled manner or as a function of the metal ion concentration in the line 10 until finally, the above-described flow conditions are set in the run-in state, in which conditions only a comparatively small partial flow is still supplied through the line 14 and a considerably larger partial flow is supplied through the line 13 to the electrolyser 1.

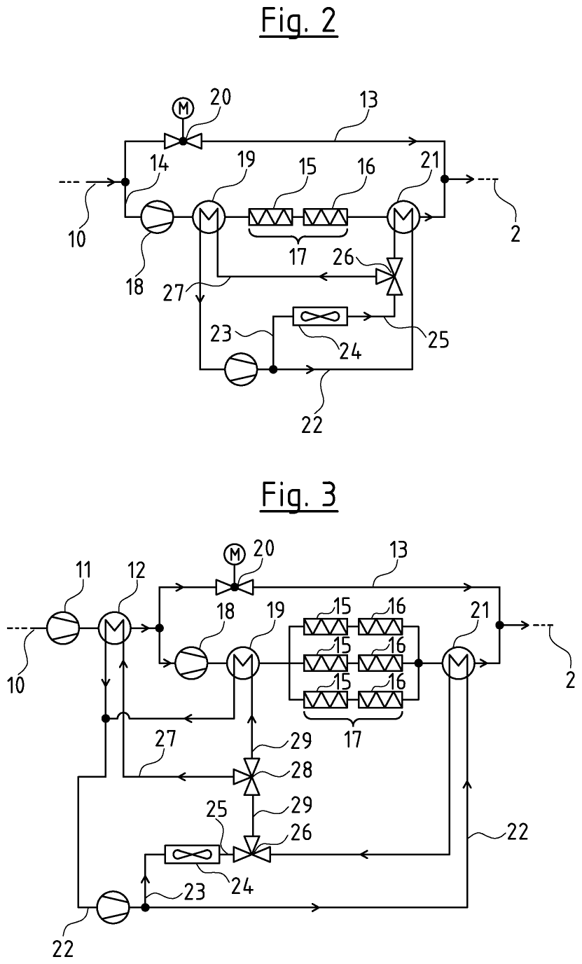

FIG. 2 illustrates how advantageously, in an electrolysis device according to FIG. 1, first a cooling of the water carried in the line 14 and, after flowing through the ion exchanger unit 17, a subsequent heating takes place. To this end, a heat exchanger 21 is connected downstream of the ion exchanger unit 17, which heat exchanger is connected via a common heat cycle to the heat exchanger 12 for cooling down the water. The heat exchangers 12 and 21 are connected to one another via a line 22, from which a line 23 to a cooling set 24 branches, to the output line 25 of which a mixing valve 26 is supplied, which is connected to the line coming from the heat exchanger 21 and into which a line 27 furthermore opens, which leads to the heat exchanger 12. Using this arrangement, the cooling down of the water carried in the line 14 upstream of the ion exchanger unit 17 and the subsequent heating via the heat exchanger 21 can take place substantially without external energy, if required, additional cooling is provided by the cooling set 24.

The configuration according to FIG. 3 is more extensive with regards to the heat carrying in a common temperature control circuit. There, the cooling unit connected via the heat exchanger 12 in FIG. 1 is connected to the previously described temperature control device for the ion exchanger unit 17, as has been described on the basis of FIG. 2. There, the output of the heat exchanger 12 and that of the heat exchanger 19 is supplied to the line 22, the output of the heat exchanger 21 and the output of the cooling set 24 are supplied to the mixing valve 26, which does not lead directly to the heat exchanger 19 however, but rather is connected via a further mixing valve 28 and a line 29 to the inlet of the heat exchanger 19 and the mixing valve 26.

In the temperature control device illustrated on the basis of FIG. 3, the heat of the entire water flow can therefore be used, which is advantageous in particular with regards to the heating following the ion exchanger unit 17 in the heat exchanger 21.

On the basis of FIG. 3, it is furthermore illustrated that three ion exchanger units 17, each consisting of a first ion exchanger 15 and a second ion exchanger 16 connected downstream of the same in the flow direction, are connected in parallel. This parallel arrangement clarifies only by way of example that by connecting a plurality of such ion exchanger units 17 in parallel, ion exchangers of virtually any desired size can be used, without having to fall back on custom-made devices here. The ion exchanger units 17 are configured in such a manner, which is known per se, that with the ageing of the ion exchanger material, if this therefore approaches its saturation, first the ion exchanger material from the downstream-connected ion exchanger 16 is placed into the upstream-connected ion exchanger 15 and the ion exchanger 16 is provided with fresh ion exchanger material, in order therefore to ensure that the treatment in the downstream-connected second ion exchanger 16 is always more intensive than in the upstream-connected ion exchanger 15.

In this case, the dimensioning of the parallel-connected ion exchanger units is configured such that at least one ion exchanger unit 17 more is present than would be required for the actual operation of the electrolysis device. This ion exchanger unit 17 can then be taken out of operation by valves, which are not illustrated here in detail, if the ion exchanger material is to be exchanged or replaced for maintenance purposes, as described previously.

The electrolysis device illustrated on the basis of the figures and described previously has a central control system, which controls both the start-up and the continuous operation automatically. Feedback control cycles are incorporated in this case, which in particular actuate the mixing valves of the temperature control circuit in a suitable manner. This control system also comprises the actuation of the shut-off valve 20 and the circulation pumps 11 and 18.

While specific embodiments of the invention have been shown and described in detail to illustrate the application of the principles of the invention, it will be understood that the invention may be embodied otherwise without departing from such principles.

1. A method for operating a water electrolysis device for generating hydrogen and oxygen from water, the method comprising the steps of:
supplying water for generating the hydrogen and the oxygen together with water for cooling to a PEM electrolyser, and the water for cooling is carried in a circuit and treated by means of a cleaning and/or separating device, wherein only part of the water carried in the circuit is supplied to the cleaning and/or separating device as a partial flow and a different part, as another partial flow is supplied to the PEM electrolyser via a bypass, which bypasses the cleaning and/or separating device.

2. The method according to claim 1, wherein at least one ion exchanger is used as the cleaning and/or separating device.

3. The method according to claim 1, wherein a ratio of the partial flows of the cooling circuit, which flow through the cleaning and/or separating device and the bypass, is set up such that a water quantity is guided through the cleaning and/or separating device every hour and treated, which is at least four times a water quantity carried in the cooling circuit.

4. The method according to claim 1, wherein during the start-up of the water electrolysis device, the water carried in the circuit is guided completely through the cleaning and/or separating device until the water has achieved at least one predetermined quality value and only subsequently is the bypass of the circuit enabled for bypassing the cleaning and/or separating device.

5. A water electrolysis device for generating hydrogen and oxygen from water, the water electrolysis device comprising:
a PEM electrolyser, which is incorporated into a cooling water circuit, via which the reaction water is also supplied;
a cleaning and/or separating device, which is connected in the cooling water circuit upstream of the electrolyser; and
a bypass provided in the circuit, via which water can be supplied to the electrolyser, bypassing the cleaning and/or separating device.

6. The water electrolysis device according to claim 5, wherein the cleaning and/or separating device comprises one ion exchanger or a plurality of ion exchangers connected in series.

7. The water electrolysis device according to claim 5, wherein that the cleaning and/or separating device comprises at least one filter.

8. The water electrolysis device according to claim 5, further comprising a cooling device or a heat exchanger of a cooling device connected upstream of the cleaning and/or separating device for cooling down incoming water.

9. The water electrolysis device according to claim 5, further comprising a heating device or a heat exchanger of a heating device connected downstream of the cleaning and/or separating device to heat the exiting water.

10. The water electrolysis device according to claim 5, further comprising pressure-increasing means, provided in the circuit and arranged in a flow path, in both flow paths and/or in the common flow path.

11. The water electrolysis device according to claim 5, wherein at least one valve is provided in the bypass, wherein the at least one valve is configured to completely or partially shut off the bypass.

12. The water electrolysis device according to claim 10, further comprising a control system configured to control the pressure-increasing means.

13. The water electrolysis device according to claim 5, wherein the cleaning and/or separating device comprises a plurality of parallel-connected ion exchanger units, which each have two ion exchangers connected in series.

14. The water electrolysis device according to claim 13, wherein the number of the parallel-connected ion exchanger units is chosen such that at maximum load, without functional impairment, one ion exchanger unit can be switched off for maintenance.

15. The water electrolysis device according to claim 8, further comprising a heating device or a heat exchanger of a heating device connected downstream of the cleaning and/or separating device to heat the exiting water, wherein the heat exchangers of the cooling and/or heating devices are assigned to a common temperature control circuit.

16. The water electrolysis device according to claim 8, further comprising a control system configured to control the cooling device.

17. The water electrolysis device according to claim 9, further comprising a control system configured to control the heating device.

18. The water electrolysis device according to claim 11, further comprising a control system configured to control the valve.

19. The water electrolysis device according to claim 8, further comprising:
a heating device or a heat exchanger of a heating device connected downstream of the cleaning and/or separating device to heat the exiting water;
a pressure-increasing means provided in the circuit and arranged in a flow path, in both flow paths and/or in the common flow path;
at least one valve in the bypass, wherein the at least one valve is configured to completely or partially shut off the bypass; and
a control system configured to control the pressure-increasing means, the valve and/or the heating and/or cooling devices in a coordinated manner.

20. A method for operating a water electrolysis device for generating hydrogen and oxygen from water, the method comprising the steps of:
providing the water electrolysis device for generating hydrogen and oxygen from water, wherein the water electrolysis device comprises: a PEM electrolyser incorporated into a cooling water circuit, via which the reaction water is also supplied; a cleaning and/or separating device connected in the cooling water circuit upstream of the electrolyser; and a bypass connected in the circuit, via which water may be supplied to the electrolyser, bypassing the cleaning and/or separating device;
supplying water for cooling to a PEM electrolyser, wherein at least a partial flow of the water for cooling is carried in the circuit and treated by the cleaning and/or separating device and another partial flow is carrier to the PEM electrolyser via the bypass.
